(19) United States
(12) Patent Application Publication
(10) Pub. No.: US 2022/0317423 A1
(43) Pub. Date: Oct. 6, 2022

(54) OPTICAL ZOOM SYSTEM

(71) Applicant: Optotune Consumer AG, Dietikon (CH)

(72) Inventors: Stephan SMOLKA, Dietikon (CH); Michael BUELER, Dietikon (CH); Johannes HAASE, Dietikon (CH); David NIEDERER, Dietikon (CH); Manuel ASCHWANDEN, Dietikon (CH); Frank BOSE, Dietikon (CH)

(73) Assignee: Optotune Consumer AG, Dietikon (CH)

(21) Appl. No.: 17/709,459

(22) Filed: Mar. 31, 2022

(30) Foreign Application Priority Data
Mar. 31, 2021 (IB) PCT/IB2021/052685

(51) Int. Cl. G02B 15/06; G02B 17/02; G02B 26/08

(52) U.S. Cl. CPC G02B 15/06; G02B 17/023; G02B 26/0875; G02B 2207/117

(57) ABSTRACT

Optical zoom system comprising an image sensor, an objective having multiple refractive surfaces and a focus tunable lens which has a tunable optical power, an expansion unit which is arranged to alter a total track length, wherein in the total track length is measured from a first refractive surface of the objective to the image sensor along the optical path.

### CROSS-REFERENCE TO RELATED APPLICATIONS

Benefit is claimed to International Patent Application No. PCT/IB2021/052685, filed on Mar. 31, 2021, the contents of which are incorporated by reference herein in their entirety.

### FIELD

The present disclosure relates to an optical zoom system. The optical zoom system is arranged to capture an image of an object, wherein a focal length, and thus an angle of view, is adjustable. The optical zoom system may be characterized by means of a zoom factor, wherein the zoom factor corresponds to the ratio of the longest to shortest focal lengths. For example, an optical zoom system with focal lengths ranging from 100 mm to 400 mm may be described as a 4:1 or “4×” zoom.

### BACKGROUND

An optical zoom system described here is based, among other things, on the following considerations. An optical zoom system which is arranged to alter the focal length by changing the optical power of one of the optical components comprised in the objective may require a large tuning range of the optical power to achieve a certain zoom factor. However, providing a tunable lens having the large tuning range of the optical power is challenging and the large changes in the optical power result in increased optical aberrations. Moreover, an optical zoom system which changes its focal power solely by changes of the total track length requires a lot of space.

### SUMMARY

The optical zoom system described here makes use of the idea, among other things, that increasing the total track length and changing the optical power of a tunable lens has a synergetic effect.

The zoom system comprises an image sensor. The image sensor may be a CCD- or CMOS-detector, which is arranged to capture an image of the object being imaged onto the image sensor.

The zoom system comprises an objective. The objective is arranged to image the object onto the image sensor. The objective comprises multiple refractive surfaces. Here and in the following, a refractive surface is formed by means of an interface between two adjacent materials having a different refractive index, wherein light when passing through the interface is refracted.

According to one embodiment, the objective comprises a first tunable lens which has a tunable optical power. According to one embodiment the zoom system comprises a second tunable lens which has a tunable optical power. The first and/or second tunable lens(es) comprise(s) at least one of the multiple refractive surfaces of the objective respectively. In particular, the optical power of the first and/or second tunable lens(es) may be tuned by changing a curvature of the refractive surface of the tunable lens respectively. In particular, two of the multiple refractive surfaces have an adjustable curvature. In particular, the curvature of said two refractive surfaces is independently adjustable.

According to one embodiment, the optical zoom an expansion unit which is arranged to alter a total track length, wherein in the total track length is measured from a first refractive surface of the objective to the image sensor along the optical path. In particular, the total track length is measured along the optical axis. Here and in the following, the first refractive surface corresponds to one of the multiple refractive surfaces, wherein the first refractive surface is the first refractive surface of the multiple refractive surfaces to be traversed by the light which is imaged on the image sensor. The total track length may be altered by changing a distance between the first refractive surface of the objective and the image sensor. Alternatively, the total track length may be altered by changing the course of the optical path, without relative movement of the image sensor with respect to the first refractive surface.

According to one embodiment, the optical zoom system comprises the image sensor, the objective and the expansion unit. The objective has multiple refractive surfaces and a focus tunable lens which has a tunable optical power. The expansion unit is arranged to alter a total track length, wherein in the total track length is measured from a first refractive surface of the objective to the image sensor along the optical path.

Advantageously, both the required tuning range for the optical power of the tunable lens decreases and the required change of the total track length is reduced, to enable the same zoom factor.

According to one embodiment, the expansion unit is arranged to alter the total track length by movement of the image sensor along an optical axis with respect to the first refractive surface. In particular, the optical zoom system comprises an actuator, which is arranged to control the position of the image sensor along the optical axis. For example, the actuator comprises a voice coil actuator or a piezo actuator. In particular, the actuator is arranged to shift the image sensor parallelly along the optical axis.

According to one embodiment, the expansion unit is arranged to alter the total track length by movement of the first refractive surface and the tunable lens along the optical axis of the tunable lens with respect to the image sensor. In particular, the tunable lens comprises the first refractive surface. The tunable lens comprises two refractive surfaces, wherein one of the two refractive surfaces has an adjustable curvature, to alter the optical power of the tunable lens. Here and in the following, moving the tunable lens along the optical axis corresponds to a movement of both of the two refractive surfaces along the optical axis. In other words, the movement of the tunable lens requires a movement of the curvature adjustable refractive surface along the optical axis by changing its curvature and an additional shift of the curvature adjustable refractive surface.

According to one embodiment of the optical zoom system, the objective comprises a first reflective element with a first reflective surface and a second reflective surface. The first reflective element may comprise a mirror or a prism. The first reflective surface and the second reflective surface may be planar surfaces, which are arranged to reflect electromagnetic radiation in a wavelength range of visible light. Alternatively, the first reflective surface and/or the second reflective surface may be curved. For example, the first reflective surface and/or the second reflective surface has a bundling effect or a stray effect on the electromagnetic radiation reflected at the first and or second reflective surface.

The first reflective surface and the second reflective surface are arranged obliquely with respect to each other. In particular, the first refractive surface and the second refractive surface are both arranged at an angle of 45° with respect to the optical axis of the objective. The optical path extends from the first refractive surface to the first reflective surface to the second reflective surface to the image sensor.

The expansion unit is arranged to alter the total track length continuously by moving the first reflective element with respect to the first refractive surface and/or with respect to the image sensor. In particular, the first reflective surface and the second reflective surface are fixedly attached to each other. For example, the first reflective is coupled to the second reflective surface mechanically. For example, when moving the reflective element the first reflective surface and the second reflective are rotated around a common axis of rotation and/or the first reflective surface and the second reflective surface perform a translational movement in a same direction by a same amount.

According to one embodiment of the optical zoom system, a first section of the optical path runs anti-parallel to a second section of the optical path. The first section of the optical path describes the course of the light immediately before it impinges on the first reflective surface, and the second section of the optical path describes the course of the light immediately after the light is reflected from the second reflective surface. In particular, the total track length is altered by moving the reflective element in a direction along the first/second section of the optical path. The feature, according to which the first and the second section of the optical path extend antiparallelly with respect to each other, circumvents aligning the image sensor and/or further reflective surfaces and/or refractive surface which are arranged downstream of the first reflective element along the optical path, when moving the first reflective element for altering the total track length. Advantageously, the antiparallel arrangement of the first and the second section with respect to each other simplifies the tuning of the total track length compared to systems in which the first and the second section extend obliquely with respect to each other.

According to one embodiment of the optical zoom system, the objective comprises a first optical pathway and a second optical pathway. In particular, an image is generated on the image sensor with light that is guided along the first optical pathway as well as with light that is guided along the second optical pathway.

The expansion unit is arranged to direct incoming light along the first optical pathway or along the second optical pathway before impinging onto the image sensor. In particular, the expansion unit comprises two discrete states, wherein in the first state, the light is directed along the first optical pathway and in the second state the light is directed along the second optical pathway. The total track length along the second optical pathway is longer than the total track length along the first optical pathway.

In particular, the second optical pathway comprises the first optical pathway. In other words, the first optical pathway is a section of the second optical pathway. Alternatively, the first optical pathway and the second optical pathway may each include sections that are not included in the other pathway respectively.

According to one embodiment of the optical zoom system, the expansion unit comprises a second reflective element, wherein an angle of the second reflective element with respect to the optical path is adjustable, and/or the expansion unit is arranged to move the second reflective element in the optical path and out of the optical path. For example, in a first state the second reflective element reflects incoming light in a first direction, in a second state the second reflective element reflects incoming light in a second direction and in a third state the second reflective element is outside of the optical path. By means of the first, second and third state of the second reflective element, the light is directed along a dedicated pathway.

According to one embodiment of the optical zoom system, the expansion unit comprises a tunable polarizing filter. The tunable polarizing filter may comprise a liquid crystal or a movable polarizing filter.

In a first state the polarization filter transmits light polarized in a first direction and in a second state the polarizing filter transmits light polarized in a second direction. The light which is polarized in the first direction is directed along the first optical pathway and the light which is polarized in the second direction is directed along the second optical pathway. In particular, the expansion unit comprises a polarization selective element, which is arranged to deflect light depending on its polarization. For example, the polarization selective element is a beam splitting polarizer, which is arranged to reflect light having a first polarization and to transmit light having a second polarization.

According to one embodiment, optical zoom system comprises an image sensor and an objective with multiple refractive surfaces, wherein the objective comprises a focus tunable lens which has a tunable optical power. A track length is larger than an installation length, wherein the installation length is defined as the length of a straight line extending from a first refractive surface to the image sensor, and the track length is defined as a length measured along the optical path from the first refractive surface to the image sensor.

Optical zoom system according to the preceding claim, wherein the optical path extends in sections obliquely with respect to a direction of the installation length.

Further advantages and advantageous refinements and developments of the optical zoom device result from the following exemplary embodiments illustrated in connection with the figures.

### BRIEF DESCRIPTION OF THE DRAWINGS

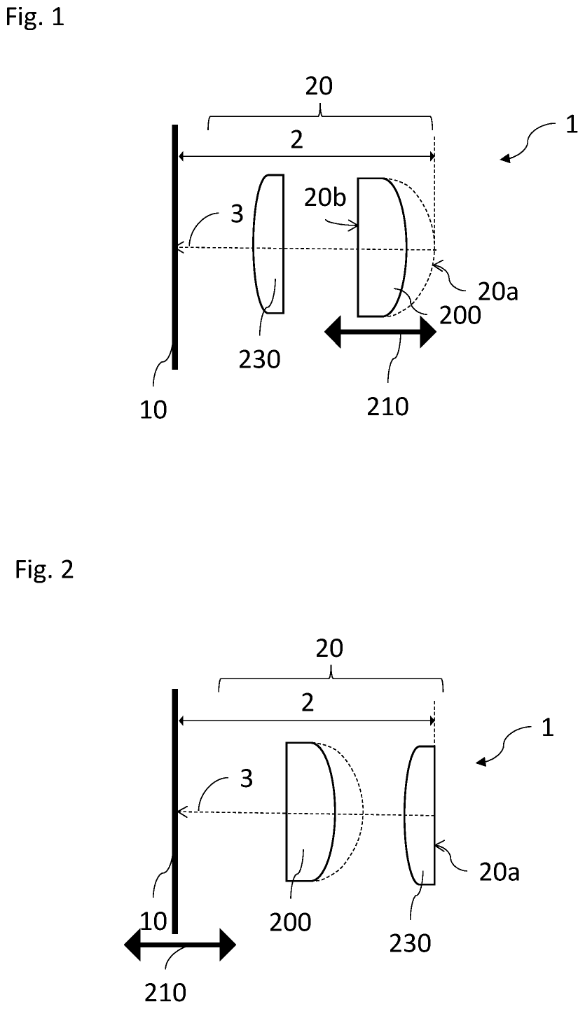

It is shown in FIGS. 1, 2, 3, 4, 5, 6, 7, 8, 9, 10A, 10B and 10C exemplary embodiments of the optical zoom system in schematic sectional views.

### DETAILED DESCRIPTION

Identical or identically acting elements are provided with the same reference symbols in the figures. The figures and the proportions of the elements shown in the figures are not to be regarded as being to scale. Rather, individual elements can be shown exaggeratedly large for better displayability and/or for better understanding.

FIG. 1 shows an exemplary embodiment of the optical zoom system 1 in a schematic sectional view. The optical zoom system 1 comprises an image sensor 10, an objective 20 having multiple refractive surfaces, an expansion unit 210 and a focus tunable lens 200 which has a tunable optical power. The tunable lens 200 comprises a first refractive surface 20a. The as illustrated by means of the dashed line, the curvature of the first refractive surface 20a is alterable, whereby the optical power of the tunable lens 200 is changed.

The expansion unit 210 is arranged to alter a total track length 2, wherein in the total track length 2 is measured from the first refractive surface 20a of the objective 20 to the image sensor 10 along the optical path 3. Here and in the following, the optical path 3 is drawn along the optical axis of the objective 20. The expansion unit 210 is arranged to alter the total track length 2 by movement of the first refractive surface 20a and the tunable lens 200 along an optical axis of the tunable lens 200 with respect to the image sensor 10. In this embodiment, the tunable lens comprises a second refractive surface 20b, the expansion unit is arranged to move both, the first 20a and the second 20b refractive surface along the optical axis 3. The objective 20 comprises a further optical component 230. In particular, the expansion unit may be arranged to move both the tunable lens 200 and the further optical component 230 along the optical axis 3 when altering the total track length 3.

In the figures, the expansion unit is represented by a double-sided arrow, which illustrates the directions in which the expansion element causes a movement for altering the total track length 3. The expansion unit 210 may comprise any actuation means which is suitable to move optical components precisely in a dedicated direction. The actuation means may comprise a piezo element, a shape memory alloy, a magnetic actuator, an electromagnetic actuator or a stepper motor. For the sake of simplified representation, the actuation means is not illustrated in the figures.

FIG. 2 shows an exemplary embodiment of the optical zoom system 1 in a schematic sectional view. The expansion unit 210 is arranged to alter the total track length 2 by movement of the image sensor 10 along the optical axis 3 with respect to the first refractive surface 20a.

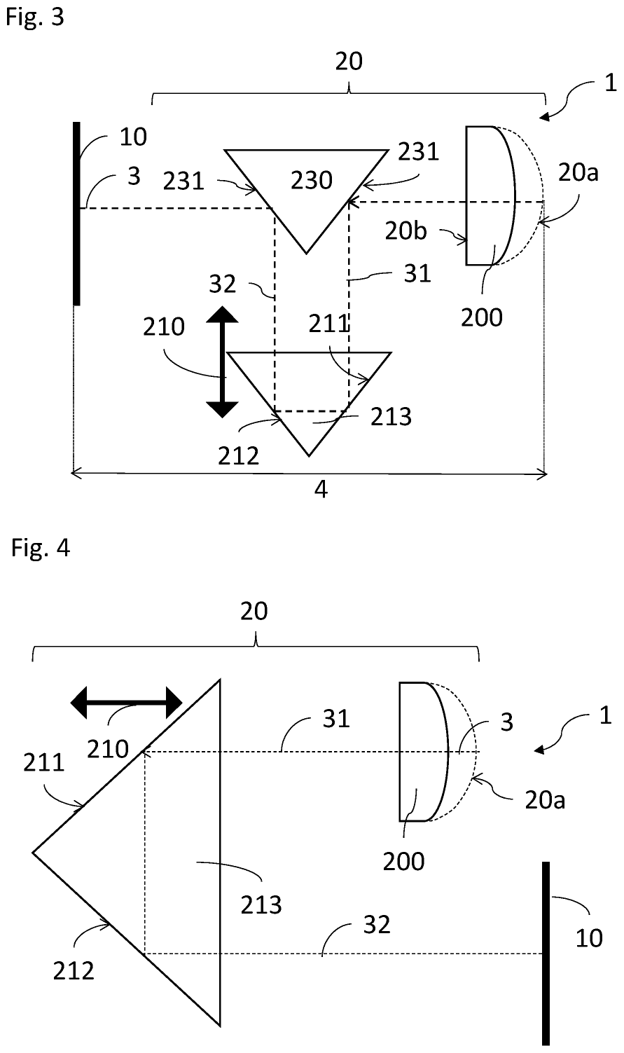

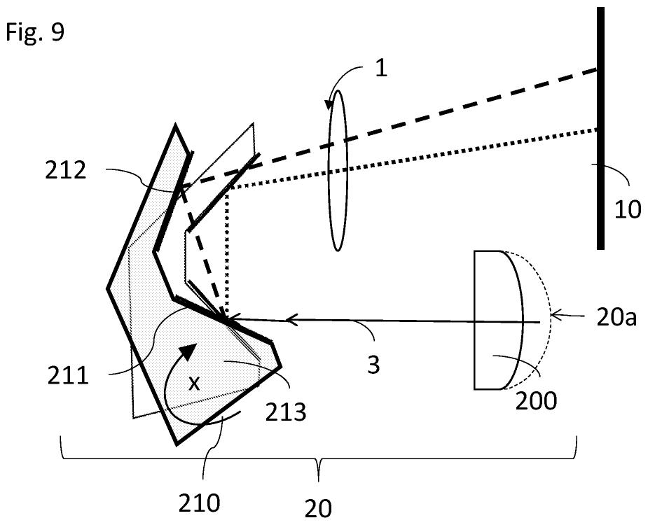

FIGS. 3, 4 and 9 show exemplary embodiments of the optical zoom system 1 in schematic sectional views. The objective 20 comprises a first reflective element 213 with a first reflective surface 211 and a second reflective surface 212. As shown in FIGS. 3 and 4, the first reflective element 213 may be a prism, which is arranged to reflect light at the first reflective surface 211 and at the second reflective surface 212 by means of total internal reflection. Alternatively, as shown in FIG. 9, the first reflective element 213 may be a mirror having the first reflective surface 211 and the second reflective surface 212.

The first reflective surface 211 and the second reflective surface 212 are arranged obliquely with respect to each other and the second refractive surface 212 is subordinate to the first refractive surface 211 along the optical path 3. The optical path 3 extends from the first refractive surface 20a to the first reflective surface 211 to the second reflective surface 212 to the image sensor 10.

As shown in the embodiment of FIG. 4, the objective 20 comprises a further optical element 230 which comprises further reflective surfaces 231. The further reflective surfaces 231 are arranged in the optical path 3, so that one of the further reflective surfaces 231 precedes the first reflective element 213 along the optical path 3 and one of the further reflective surfaces 231 follows the first reflective element 213 along the optical path 3. In particular, the further optical component 230 and the first reflective element 213 are arranged such that a first section of the optical path 31 and a second section 32 of the optical path extend antiparallel with respect to each other. The first section 31 of the optical path 3 describes the course of the light immediately before it impinges on the first reflective surface 211, and the second section 32 of the optical path 3 describes the course of the light immediately after the light is reflected on the second reflective surface 212.

The expansion unit 210 is arranged to alter the total track length 2 continuously by moving the first reflective element 213 with respect to the further optical component 230, in particular with respect to the first refractive surface 20a and with respect to the image sensor 10. In particular, the total track length is altered by changing the length of the first section 31 and the second section 32 of the optical path simultaneously. Advantageously, changing the length of the total track length 2 does not result in any changes of incident angles of the light onto the first reflective element 213 or the further optical component 230.

The embodiment of FIG. 4 does not comprise the further optical component 230. Thus, the first section 31 extends between the tunable lens 200 and the first reflective surface 211 and the second section 32 extends between the second reflective surface 32 and the sensor 10. The expansion unit 210 is arranged to alter the total track length 2 continuously by moving the first reflective element 213 with respect to the first refractive surface 20a and with respect to the image sensor 10. In particular, the image sensor 10 or the tunable lens 200 may be mechanically coupled to the first reflective element 213. Thus, the total track length 2 is altered by moving the first reflective element 213 with respect to the first refractive surface 20a or with respect to the image sensor 10.

FIG. 3 shows an embodiment of the optical zoom system 1, comprising the image sensor 10, the objective 20 with multiple refractive surfaces 20a, 20b. The objective 20 comprises the focus tunable lens 200 which has a tunable optical power. The total track length 2 is larger than an installation length 4, wherein the installation length 4 is defined as the length of a straight line extending from the first refractive surface 20a to the image sensor 10. The optical path 3 extends in sections 31, 32 obliquely with respect to a direction of the installation length 4. In particular, the first section 31 and the second section 32 extend orthogonally with respect to the direction of the installation length 4.

FIG. 9 shows an embodiment of the optical zoom system 1 wherein the first reflective element 213 is rotatably mounted. Thus, the first reflective surface 211 and the second reflective surface 212 are rotatable around a common axis of rotation, which is indicated by an X. The expansion unit 210 is arranged to rotate the first reflective element 213 around the axis of rotation. The rotation of the first reflective element 213 alters the incident angle of the light onto the first and second reflective surface 211, 212. Thereby, both, the length and the direction of the optical path 3 are being altered. For example, in a first state the light spreads along a first pathway 21 and in a second state 22 the light spreads along a second pathway 22. The expansion element 210 is arranged to change the direction and the length of the optical pathway 3 continuously.

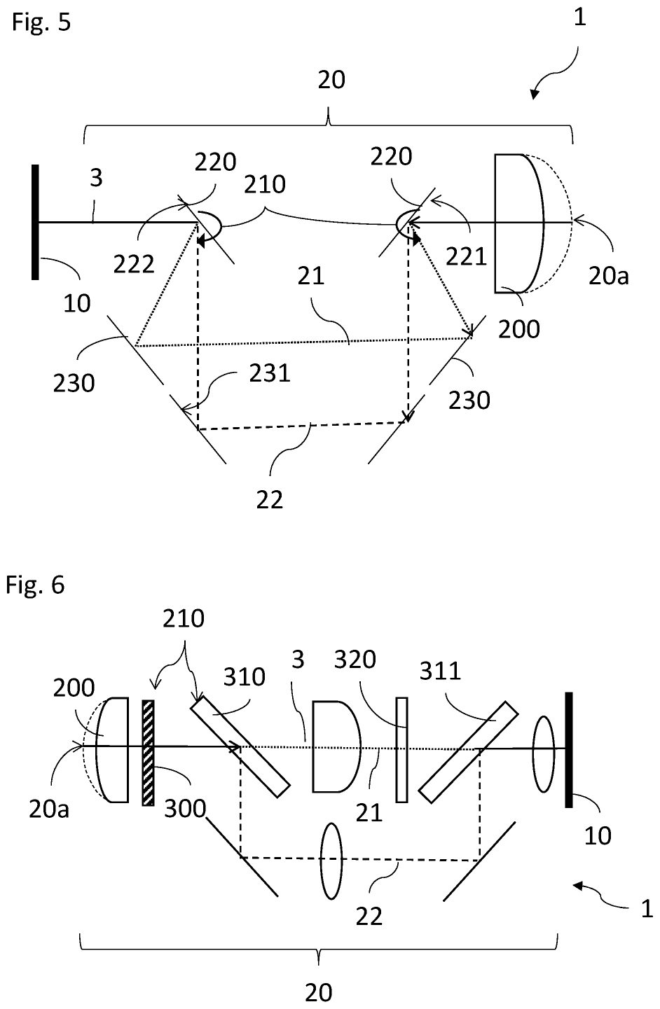

FIG. 5 shows an exemplary embodiment of the optical zoom system 1 in a schematic sectional view. The objective 20 comprises a first optical pathway 21 and a second optical pathway 22. The expansion unit 210 is arranged to direct incoming light along the first optical pathway 21 or the second optical pathway 22 before impinging onto the image sensor 10. The total track length 2 along the second optical pathway 22 is longer than the total track length 2 along the first optical pathway 21.

The expansion unit 210 comprises a second reflective element 220, wherein an angle of the second reflective element 220 with respect to the optical path 3 is adjustable. The second reflective element 220 comprises a third reflective surface 221 and a fourth reflective surface 222. The expansion unit 210 is arranged to rotate the third and fourth reflective surface 221, 222 to direct the light along the first pathway 21 or the second pathway 22. The objective 20 comprises further optical components 230 having further reflective surfaces 231, which define the first 21 and second 22 optical pathway.

FIG. 6 shows an exemplary embodiment of the optical zoom system 1 in a schematic sectional view. The expansion unit 210 comprises a tunable polarizing filter 300. In a first state the polarizing filter 300 transmits light polarized in a first direction, in a second state the polarizing filter 300 transmits light polarized in a second direction. In particular, the polarizing filter 300 is a liquid crystal which is arranged to adjust the polarization of the transmitted light. Alternatively, the polarizing filter may be a polarizing plate which is rotatably mounted, wherein the direction of the polarized light is defined by means of rotating the polarizing filter. The light which is transmitted through the polarizing filter 300 impinges onto a beam splitter 310. The beam splitter 310 directs the light polarized in the first direction along the first optical pathway 21 and light polarized in the second direction along the second optical pathway 22. The objective 20 comprises a further beam splitter 311 which is arranged to overlay light coming from the first optical pathway 21 or the second optical pathway 22. Along the first optical pathway, the objective comprises a quarter lambda plate 320, which is arranged to adjust the polarization of the light in the first pathway 21, in order to be transmitted through the further beam splitter 311.

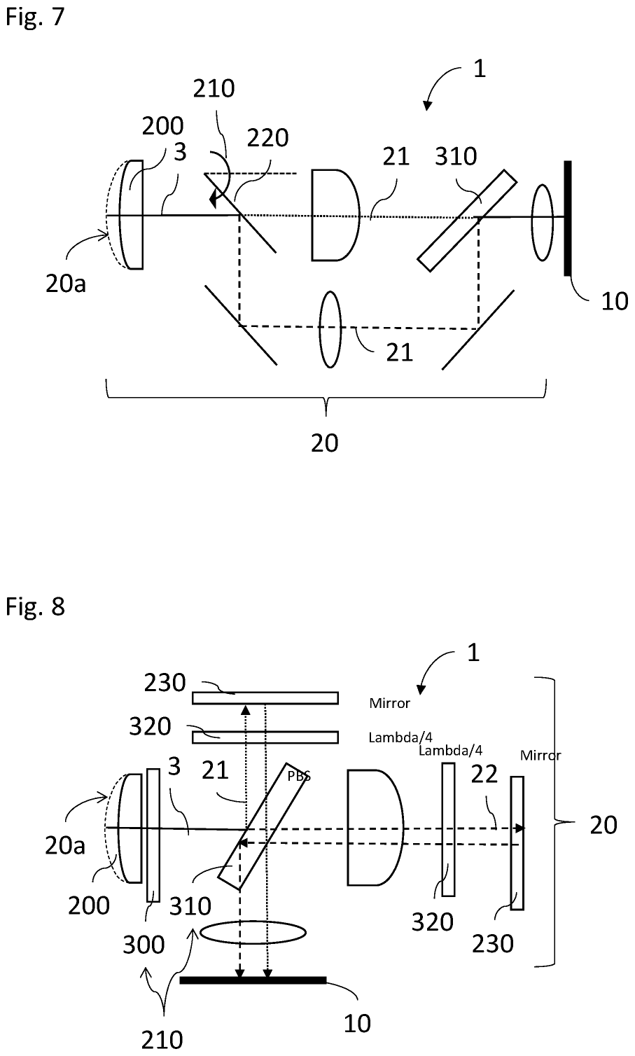

FIG. 7 shows an exemplary embodiment of the optical zoom system 1 in a schematic sectional view. The objective 20 comprises a second reflective element 220. The expansion unit 210 is arranged to move the second reflective element 220 in the optical path 3 and out of the optical path 3. In a first state of the expansion unit 210, the second reflective element 220 is in the optical path 3. In the first state, the second reflective element 220 directs the light along the second optical pathway 22 (dashed lines). In a second state, the second reflective element 220 is out of the optical path 3 and the second reflective element 220 does not interact with the light. The light is directed along the firth optical pathway 21 (dotted lines).

FIG. 8 shows an exemplary embodiment of the optical zoom system 1 in a schematic sectional view. Similar to the embodiment shown in FIG. 6, the objective 20, in particular the expansion unit 210, comprises a polarizing filter 300 and a beam splitter 310. The expansion unit 210 is arranged to direct the light along the first pathway 21 or the second pathway 22. When the light is directed along the first pathway 21, the polarizing filter is arranged to transmit light which is reflected at the beam splitter 310. The first pathway 21 comprises a lambda quarter plate 320, which alters the polarization of the light expanding along the first pathway 21, so that the light expanding along the first pathway 21 is transmitted through the beam splitter after traversing the lambda quarter plate 320. The second pathway 22 comprises a lambda quarter plate 320, which alters the polarization of the light expanding along the second pathway 22, so that the light expanding along the second pathway 22 is reflected by the beam splitter 310 after traversing the lambda quarter plate 320.

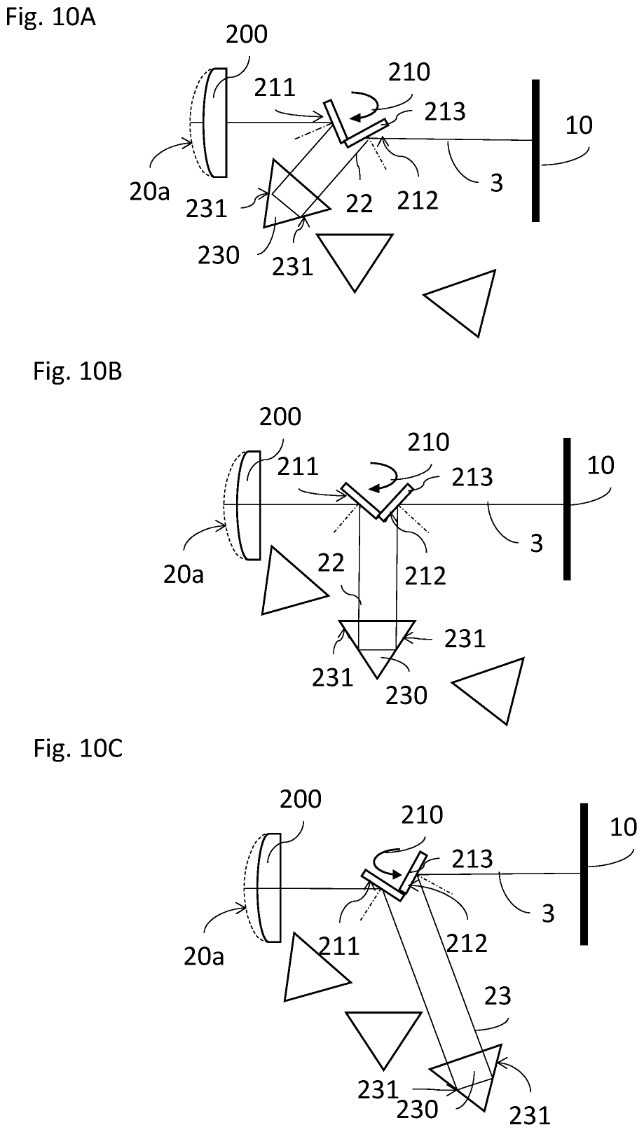

The FIGS. 10A, 10B and 10C show an exemplary embodiment of the optical zoom system 1 in schematic sectional views. The optical zoom system 1 comprises a first reflective element 213 with a first and a second reflective surface 211, 212. The expansion unit 210 is arranged to alter the optical path by rotating first reflective element 213. The rotational position of the first reflective element defines which of multiple further optical components 230 reflects the light to the first reflective element 213. Thus, the rotation of the first reflective element 213 results in discrete changes of the total track length 2. The different distances between the first reflective element 213 and the different further optical components 230 result in a different total track length 2 of the different optical pathways 21, 22, 23

The invention is not restricted to the exemplary embodiments by the description thereof. Rather, the invention encompasses any new feature and any combination of features, which in particular includes any combination of features in the patent claims, even if this feature or this combination itself is not explicitly specified in the patent claims or exemplary embodiments.

### LIST OF REFERENCE SIGNS

1 Optical zoom system
2 Total track length
3 Optical axis, optical path
10 Image sensor
20 Objective
21 First optical pathway
22 Second optical pathway
20a First refractive surface
20b Second refractive surface
31 First section of the optical path
32 Second section of the optical path
210 Expansion unit
230 Further optical element
231 Further reflective surface
211 First reflective surface
212 Second reflective surface
213 First reflective element
220 Second reflective element
221 Third reflective surface
222 Fourth reflective surface
300 Liquid crystal
310 Beam splitter
311 Further beam splitter
320 Quarter lambda plate

We claim:

1. Optical zoom system comprising
an image sensor,
an objective having multiple refractive surfaces and a focus tunable lens which has a tunable optical power,
an expansion unit which is arranged to alter a total track length, wherein in the total track length is measured from a first refractive surface of the objective to the image sensor along the optical path.

2. Optical zoom system according to claim 1, wherein the expansion unit is arranged to alter the total track length by movement of the image sensor along an optical axis with respect to the first refractive surface.

3. Optical zoom system according to claim 1, wherein the expansion unit is arranged to alter the total track length by movement of the first refractive surface and the tunable lens along an optical axis of the tunable lens with respect to the image sensor.

4. Optical zoom system according to claim 1, wherein
the objective comprises a first reflective element with a first reflective surface and a second reflective surface,
the first reflective surface and the second reflective surface are arranged obliquely with respect to each other,
the optical path extends from the first refractive surface to the first reflective surface to the second reflective surface to the image sensor, and
the expansion unit is arranged to alter the total track length continuously by moving the first reflective element with respect to the first refractive surface and/or with respect to the image sensor.

5. Optical zoom system according to claim 4, wherein
a first section of the optical path runs anti-parallel to a second section of the optical path, wherein
the first section of the optical path describes the course of the light immediately before it impinges on the first reflective surface, and
the second section of the optical path describes the course of the light immediately after the light is reflected on the second reflective surface.

6. Optical zoom system according to claim 1, wherein
the objective comprises a first optical pathway and a second optical pathway, the expansion unit is arranged to direct incoming light along the first optical pathway or the second optical pathway before impinging onto the image sensor, wherein
the total track length along the second optical pathway is longer than the total track length along the first optical pathway.

7. Optical zoom system according to claim 6, wherein the expansion unit comprises a second reflective element, wherein
an angle of the second reflective element with respect to the optical path is adjustable, and/or the expansion unit is arranged to move the second reflective element in the optical path and out of the optical path.

8. Optical zoom system according to claim 6, wherein
the expansion unit comprises a tunable polarizing filter, wherein
in a first state the polarizing filter transmits light polarized in a first direction,
in a second state the polarizing filter transmits light polarized in a second direction, and
the light polarized in the first direction is directed along the first optical pathway and light polarized in the second direction is directed along the second optical pathway.

9. Optical zoom system comprising
an image sensor,
an objective with multiple refractive surfaces, wherein
the objective comprises a focus tunable lens which has a tunable optical power,
a total track length is larger than an installation length, wherein
the installation length is defined as the length of a straight line extending from a first refractive surface to the image sensor, and
a total track length is defined as a length measured along the optical path from the first refractive surface to the image sensor.

10. Optical zoom system according to claim 9, wherein the optical path extends in sections obliquely with respect to a direction of the installation length.
